(19) United States
(12) Patent Application Publication
(10) Pub. No.: US 2001/0054649 A1
(43) Pub. Date: Dec. 27, 2001

(54) Atomizing apparatus and method

(76) Inventor: Tomihisa Naito, Odawara-shi (JP)

Correspondence Address: HELLER EHRMAN WHITE & MCAULIFFE LLP, 1666 K STREET,NW, SUITE 300, WASHINGTON, DC, 20006, US

(21) Appl. No.: 09/879,034

(22) Filed: Jun. 13, 2001

(30) Foreign Application Priority Data
Jun. 16, 2000 (JP) 2000-181600

(51) Int. Cl. A62C 5/02; B05B 7/16

(52) U.S. Cl. 239/8; 239/128

(57) ABSTRACT

In atomizing apparatus as described herein comprises an outer cylinder having an inlet and an outlet and an inner cylinder slidably disposed in the outer cylinder moving in an axial direction. The particular inner cylinder comprises a plurality of holes therein which are exposed to a processing chamber. The holes may be axially arranged along the inner cylinder into groups having substantially the same diameter. The instant apparatus demonstrates superior processing efficiency and homogenization. A method of atomizing a desired substance with the instant apparatus is also described.

### BACKGROUND OF THE INVENTION

1. Field of Invention

The present invention relates to an apparatus and related methods for atomizing substances handled in various fields, such as foods, chemicals and pharmaceuticals, and more particularly, to an apparatus for uniformly or homogeneously atomizing an emulsified, dispersed, stirred, or crushed substance into micron or submicron particular sizes, and thereby obtaining atomized matter having stable particulate distribution.

2. Description of Related Art

An APV-type Gorlin homogenizer is an example of a typical prior art atomizing apparatus and uses a principle shown in FIG. 1. In FIG. 1, a valve 2 is opposed to a valve seat 1 with a slight clearance therebetween, wherein a raw material is injected from the clearance radially outward under high pressure, thereby allowing the raw material to collide against an inner diameter wall of impact ring 3 so that a one or more substances in the raw material is atomized and homogenized, and the resultant material is taken out from body 4. Based on this principle, such an apparatus can atomize particles with varied particle diameters and obtain a desired processing amount, normally 10 ton/hr of material under normal processing pressures, such as around 107 Pa. However, these conventional apparatus have a disadvantage in terms of inferior processing efficiency.

Another apparatus for atomizing pressurized raw material comprises a generator having a thin tube having a small diameter or orifice, such as described in Japanese Patent Application No. 3002432 filed by the present inventor the content of which incororated herein by reference. While such an apparatus demonstrates superior processing efficiency, the generator must be exchanged whenever the particle size is varied.

Thus, an atomizing apparatus with excellent atomizing efficiency without the need for exchanging the generator whenever the particle size is varied is desirable. An atomizing apparatus that functions as a multi-generator which can be widely used in various field is also particularly desirable.

### SUMMARY OF THE INVENTION

In a preferred embodiment, the instant invention provides an atomizing apparatus, comprising: an outer cylinder connected to an outlet; an inlet which is connected to the outer cylinder which is perpendicular to an axial direction of the outer cylinder; a chamber formed at an intersection of the outer cylinder and the inlet, wherein the chamber is in fluid communication with said inlet; and an inner cylinder fitted inside the outer cylinder, wherein the inner cylinder contains a plurality of holes exposed to the chamber.

In another preferred embodiment, the instant invention provides a method of preparing an atomized substance comprising: pressurizing a raw material; supplying the pressurized raw material to an atomizing apparatus of the instant invention; and atomizing a substance in the raw material to obtain an atomized substance.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a view of a conventional apparatus;

FIG. 2 is a view showing a system of a preferred embodiment of the present invention;

FIG. 3 is a vertical sectional view of an apparatus body of a preferred embodiment of the present invention;

FIG. 4 is a sectional view taken along a line IV-IV in FIG. 3; and

FIG. 5 is a sectional view of an apparatus of a preferred embodiment of the invention.

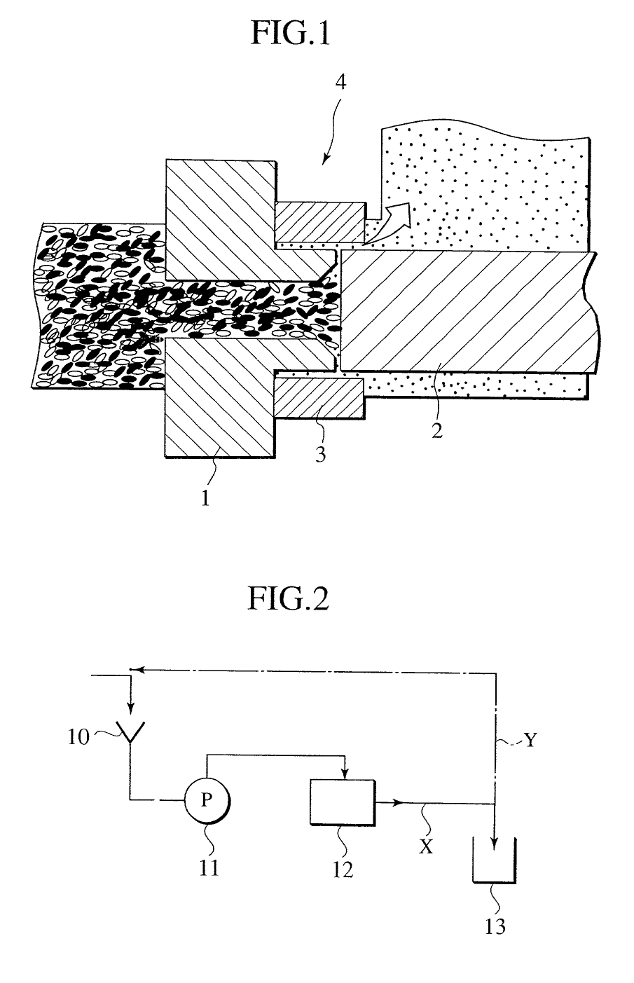

### DESCRIPTION OF THE PREFERRED EMBODIMENTS

The instant invention provides an atomizing apparatus for pressurizing a raw material supplied by a raw material supply port and sending the pressurized raw material to an apparatus body where one or more substances in the raw material is atomized by the apparatus body and taken out.

FIG. 2 shows a preferred embodiment of the invention wherein a raw material is supplied by raw material supply port 10, and is pressurized by a high-pressure pump 11, such as a plunger type pump having pressure of about 106 to 107 Pa, and sent to apparatus 12. In apparatus 12, the material is atomized and sent to receiving container 13 through a passage shown as solid line X. When the material is atomized, the material may be returned to raw material supply port 10 through a passage shown with as chain line Y and further atomized.

The apparatus body comprises an outer cylinder having an inlet which is perpendicular to an axial direction of the outer cylinder and an outlet disposed at an axial end of the outer cylinder. An inner cylinder is disposed within the outer cylinder such that an outer periphery of the inner cylinder may abut against an inner periphery of the outer cylinder, and the inner cylinder is movable in the axial direction by operation from a side of the outer cylinder opposite the outlet. The inner cylinder comprises a plurality of holes, which may be arranged in groups of holes having substantially the same diameter. In a preferred embodiment, a single group of holes having substantially the same diameter are exposed to a chamber connected to the inlet by operating and moving the inner cylinder in the axial direction.

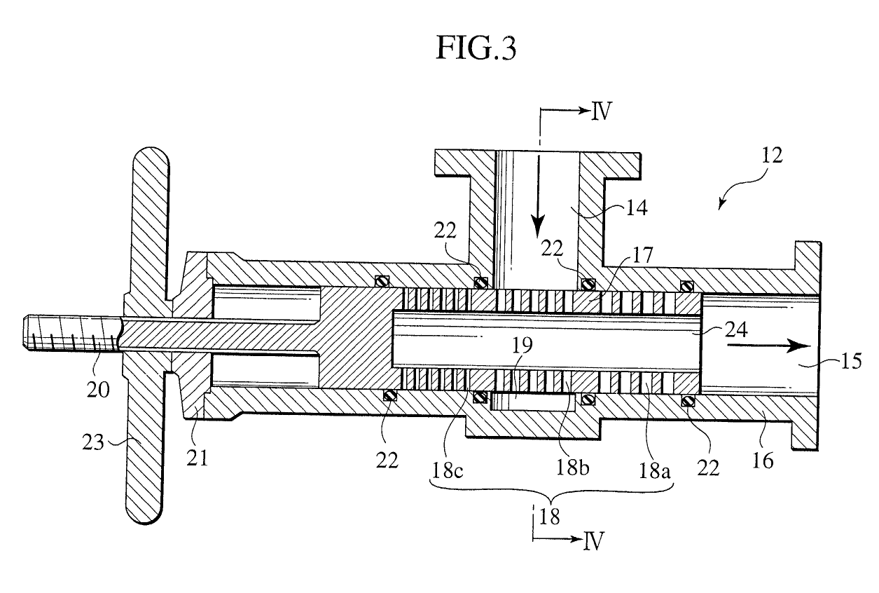

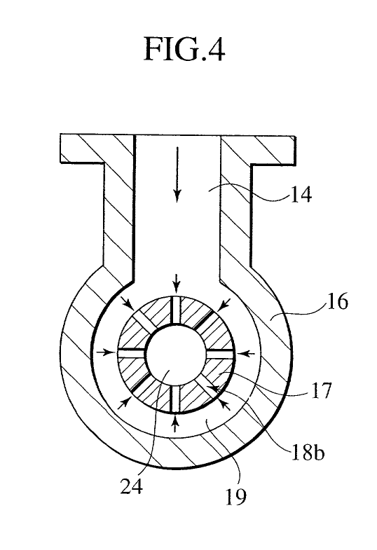

A preferred embodiment is shown in FIG. 3, wherein body 12 includes a hard stainless outer cylinder 16 and a super-hard ceramic inner cylinder 17 which is slidably and movably fitted into outer cylinder 16. The outer cylinder 16 includes an inlet 14 which is perpendicular to an axial direction of the cylinder 16 at right angles, and an outlet 15 directed at an axial direction. The inner cylinder 17 has a large number of holes 18 passing into a passage 24 therein. These holes are arranged in a plurality of groups in the axial direction based on diameter. For example, among holes 18, four large holes 18a each having a diameter, for example, of 0.8 mm, are arranged in the axial direction in four rows to constitute group A. Six middle holes 18b each having a diameter, for example, of 0.5 mm, are arranged on the left side of the large holes 18a to constitute a group B . Seven small holes 18c each having a diameter of, for example, 0.2 mm, are arranged on the left side of the middle holes 18b to constitute a group C. The groups A, B and C are arranged in this order. In FIG. 3, the holes 18b of the group B are exposed to a pressurizing chamber 19, such as a high-pressure atomization and processing chamber which is in fluid communication with inlet 14 (see also FIG. 4). Groups A and C may also be exposed to the chamber 19. This can be achieved by turning handle 23 to move handle 23 leftward along screw 20 shown in FIG. 3, and separating handle 23 from lid 21 which is integral with outer cylinder 16 and turning the screw 20 which is integral with inner cylinder 17 to move handle 23 to an original position with respect to lid 21 along screw 20 and fastening handle 23 and setting the latter to a normal position.

Based on FIG. 3, one of ordinary skill will appreciate that inner cylinder 17 may be formed with groups of holes 18 having small, mid and large diameters. When pressurized raw material supplied to inlet 14 passes through a group of large diameter holes exposed to chamber 19, a substance in a raw material is atomized into rough particle size, and the substance flows into outlet 15 through passage 24 in inner cylinder 17. If inner cylinder 17 is slidably moved by turning handle 23 so that holes having a mid-sized diameter are exposed, the substance is further atomized into mid-sized particles. If inner cylinder 17 is further moved so that holes 18 having a small diameter are exposed, the substance is atomized into super-fine sized particles. Accordingly, the substance is atomized efficiently in proportion to diameter of holes 18. The number of holes having large diameter may be reduced, and the number of holes having small diameter may be increased and vice versa. The number of holes of the groups may be the same or not the same, and the number of holes is not limited. In any event, the processing amount is equal since speed is inversely proportional to the diameter of the hole.

In addition, it is possible to increase the number of processing cycles to achieve super-fine atomization and efficient homogenization of materials. Preferably, a group of large holes 18 is used in initial cycles, and the apparatus is adjusted for mid-sized holes in a subsequent cycles, and finally a group of small holes is used in the last cycles. The reason is that if an attempt is made to finely atomize a rough substance initially, course particles will be mixed and there is a possibility that clusters may be generated and block the holes. Secondly, the frequency of sound wave undulations is inversely proportional to the diameter of the hole. Thus, if the diameter is large, the frequency is low and vice versa. In this connection, it is preferable to use larger diameters with low frequency for course particles, and preferable to use smaller diameters with higher frequency for finer particles. In this manner, homogenization and processing is maximally optimized.

Based on the foregoing, it will be appreciated that the instant apparatus can process substances having different particle sizes while using only a single apparatus body. Also, the apparatus of the instant invention can be utilized as a multi-generator since it can be used in a variety of fields. Comparatively, an apparatus of the invention is superior by 30 to 50% in terms of processing efficiency over those conventional APV-type apparatus of the prior art.

In FIG. 3 an inner-diameter portion 22 of the outer cylinder 16 is a pressure-leakage preventing member for preventing high pressure from leaking outside by means of O-rings fitted into four grooves formed in the axial direction. Here, in a stage in which the handle 23 is set normally, all of the holes 18a, 18b and 18c of the groups A, B and C exposed to the chamber 19 are equally accommodated between adjacent O-rings 22 in the axial direction.

Another preferred embodiment is shown in FIG. 4 wherein eight holes 18b are opposed to one another on the same circumference of inner cylinder 17. In this embodiment, a high-speed flow of material into holes 18b from pressurizing chamber 19 collide against each other in a head-on manner at center passage 24, and energy caused by the collision becomes as great as eight times of that of a conventional one hole flow speed, whereby excellent processing efficiency in terms of atomization is achieved. In this case, it is preferable to select an optimal value for an inner diameter of center passage 24. If the inner diameter is too small, the high speed flow can not be obtained due to resistance, and if the inner diameter is too large, a great collision effect can not be obtained due to dispersion and dissipation. Those optimal diameters for center passage 24 are within the skill of the artisan and therefore well within the scope of the invention.

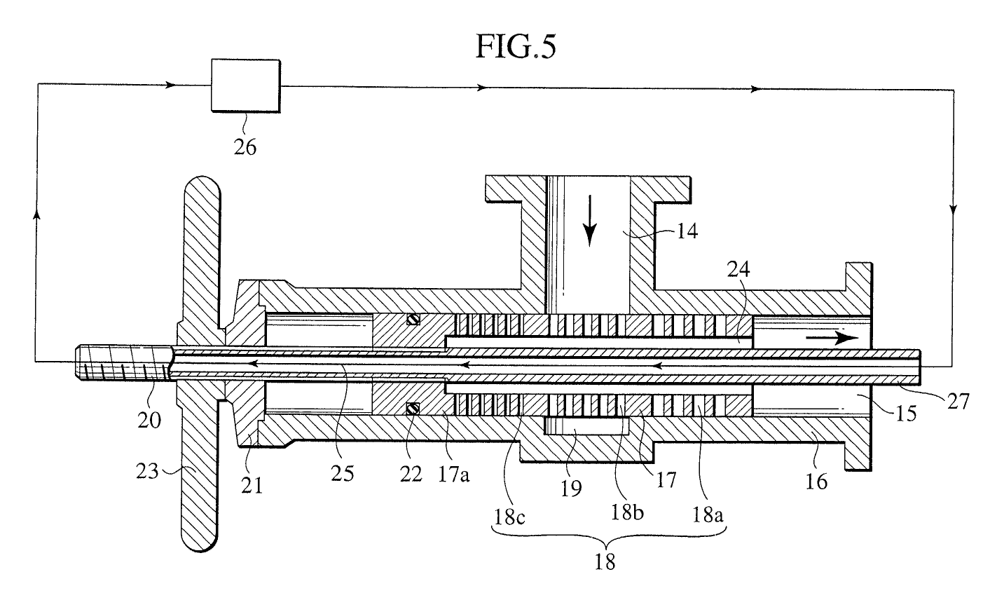

Another preferred embodiment is shown in FIG. 5 wherein inner cylinder 17 is provided with water passage 25 and it is feasible to adjust the temperature of the apparatus with temperature adjusting device 26. For example, screw rod 20 may be formed as a separate long tube 27 and fixed to a base 17a of inner cylinder 17. This way processing can be further optimized by cooling the apparatus when heat should be avoided, such as in the production of pharmaceuticals, foods and the like, and heat the apparatus when atomization is facilitated at higher temperatures, e.g. high viscosity or when crystal structure may be deformed. In any case, excellent atomization processing may be achieved through temperature regulation in this manner.

Conveniently, the instant apparatus is easily manufactured since the concentric inner and outer cylinders may be easily manufactured by mechanical formation. Further, hole formation through cylinder walls may be accomplished by any conventional method.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

As used herein and in the following claims, articles such as “the”, “a” and “an” can connote the singular or plural.

All documents referred to herein are specifically incorporated herein by reference in their entireties.

The priority document, Japanese Patent Application No. 2000-181600, filed Jun. 16, 2000 is expressly incorporated herein by reference in its entirety.

What is claimed is:

1. An atomizing apparatus, comprising:
an outer cylinder connected to an outlet;
an inlet which is connected to said outer cylinder, said inlet being perpendicular to an axial direction of said outer cylinder;
a chamber formed at an intersection of said outer cylinder and said inlet, wherein said chamber is in fluid communication with said inlet; and
an inner cylinder fitted inside said outer cylinder, wherein said inner cylinder contains a plurality of holes exposed to said chamber.

2. An atomizing apparatus according to claim 1, wherein said holes in said inner cylinder are arranged as groups of holes, wherein each group contains holes with substantially the same diameter relative to one another, wherein a single group of holes is exposed to said chamber.

3. An atomizing apparatus according to claim 1, wherein an outer periphery of said inner cylinder abuts against an inner periphery of said cylinder, wherein said inner cylinder slidably moves in said axial direction.

4. An atomizing apparatus according to claim 1, wherein said plurality of holes are opposed to one another on a circumference that is the same as a circumference of said inner cylinder.

5. An atomizing apparatus according to claim 1, wherein said chamber is a pressurizing chamber, which is capable of carrying out atomization therein.

6. An atomizing apparatus according to claim 1, further comprising a plurality of pressure-leakage preventing members fitted into an inner diameter of said outer cylinder, whereby said pressure-leakage preventing members abut an outer periphery of said inner cylinder.

7. An atomizing apparatus according to claim 1, further comprising a water passage provided in said inner cylinder, whereby atomization temperature is capable of being adjusted by adjusting temperature of water in said water passage.

8. An atomizing apparatus according to claim 1, further comprising a conduit passage connecting said outlet and a raw material supply port, whereby atomized material may be returned to said supply port through said conduit passage.

9. An atomizing apparatus according to claim 1, wherein said inner cylinder is connected to a screw positioned opposite said outlet of said outer cylinder, whereby said inner cylinder moves in said axial direction by turning said screw.

10. A method of preparing an atomized substance comprising:
a) pressurizing a raw material;
b) supplying said pressurized raw material to an atomizing apparatus; and
c) atomizing a substance in said raw material to obtain an atomized substance.

11. A method of atomizing a substance according to claim 10, further comprising returning said atomized substance to said atomizing apparatus and re-atomizing said atomized substance to obtain a super-fine material.

12. A method according to claim 10, wherein said atomizing apparatus comprises:
an outer cylinder connected to an outlet;
an inlet which is connected to said outer cylinder, said inlet being perpendicular to an axial direction of said outer cylinder;
a chamber formed at an intersection of said outer cylinder and said inlet, wherein said chamber is in fluid communication with said inlet; and
an inner cylinder fitted inside said outer cylinder, wherein said inner cylinder contains a plurality of holes exposed to said chamber.
